(19) United States
(12) Patent Application Publication
(10) Pub. No.: US 2020/0355270 A1
(43) Pub. Date: Nov. 12, 2020

(54) LEAK-PROOF PLUNGER PUMP

(71) Applicants: Xiaorong Li, Taizhou (CN); Fazheng Yang, Taizhou (CN)

(72) Inventors: Xiaorong Li, Taizhou (CN); Fazheng Yang, Taizhou (CN)

(73) Assignee: Zhejiang Rongpen Air Tools Co., Ltd.

(21) Appl. No.: 16/406,018

(22) Filed: May 8, 2019

(51) Int. Cl. F16J 15/3232

(52) U.S. Cl. CPC F16J 15/3232

(57) ABSTRACT

A leak-proof plunger pump comprising a plunger base, a reciprocation hole, and a plunger rod matching the reciprocation hole. The outer wall of the lower portion of the plunger base includes external threads and a plug gasket having movement hole matching the plunger rod; the upper surface of the plunger base has a first upper mounting slot, and the lower surface of said plunger base has a first lower mounting slot; the upper surface of the plug gasket includes a second upper mounting slot, and the lower surface of said plug gasket includes a second lower mounting slot; a guide sleeve is configured inside both the first upper mounting slot and the second lower mounting slot. The leak-proof plunger pump can maximize the leak-tightness during the reciprocating movement of the plunger rod, avoid leakage and maintain good operational performance of the plunger pump.

### BACKGROUND OF INVENTION

### 1. Field of the Invention

The present invention relates to a leak-proof plunger pump.

### 2. Description of Related Art

Through reciprocating movement of the plunger rod inside the cylinder to vary the volume of the sealed working chamber, a plunger pump can realize the function of pressure boost. The motion path of the plunger rod is determined by the plunger base sleeved outside the plunger rod. In actual use, the plunger rod may have a deflection. In case of deflection of the plunger rod, the seal ring sleeved outside the plunger rod will have increased friction on one side, causing uneven wear. However, in a conventional plunger pump, the plunger rod is configured with only one seal ring. When uneven wear occurs to the seal ring, the leak-tightness can not be guaranteed and liquid leakage may happen. As a consequence, the effect of pressure boost is affected, causing poor operational performance of the plunger pump.

### SUMMARY OF THE INVENTION

The purpose of the present invention is to overcome the deficiencies in the existing technology to provide a leak-proof plunger pump.

In order to solve the above problems, the technical scheme of the present invention is described below

A leak-proof plunger pump, comprising; a plunger base, a reciprocation hole configured on the plunger base, and a plunger rod matching the reciprocation hole; the plunger base having external threads disposed on an outer wall of a lower portion thereof;

wherein the plunger base includes a plug gasket, disposed therebelow, a movement hole disposed on the plug gasket and matching the plunger rod, a first upper mounting slot disposed on an upper surface of the plunger base, and a first lower mounting slot disposed on a lower surface of the plunger base;

wherein the plug gasket includes a second upper mounting slot disposed on an upper surface thereof and a second lower mounting slot disposed on a lower surface thereof; both the first upper mounting slot and the second lower mounting slot includes a guide sleeve disposed therein, and the guide sleeves are both sleeved outside the plunger rod; a bottom of the first lower mounting slot has an upper seal structure, an inside of the second upper mounting slot has a middle seal structure, an opening of the second lower mounting slot has a lower seal structure, the lower seal structure tightly pressing on the lower surface of the guide sleeve disposed inside the second lower mounting slot; the upper seal structure and middle seal structure are separated by an annular spacer, and the inner wall of the spacer and the outer wall of the plunger rod have a movement gap disposed therebetween.

More particularly, wherein the upper seal structure, middle seal structure and lower seal structure are identical, all of the upper seal structure, middle seal structure and lower seal structure are made up of a seal ring and an O ring, and the seal ring is sleeved outside the plunger rod; a lower portion of the seal ring includes an annular lip-shaped slot, and the O ring is disposed inside the lip-shaped slot; the inner wall of the upper portion of the seal ring and the outer wall of the plunger rod include an adjustment gap disposed therebetween, whereas the inner wall of the lower portion of the seal ring is tightly pressed on the outer wall of the plunger rod under the pressure from the O ring; an opening of the second upper mounting slot has an annular mounting stage, and the spacer is disposed on the mounting stage.

More particularly, wherein the lower surface of the plunger base includes an annular first slot; and an inside of the first slot has a matching first rubber ring; the lower surface of the plunger base is pressed on the upper surface of the plug gasket.

More particularly, wherein the upper seal structure and lower seal structure are identical, the upper seal structure and lower seal structure are both made up of a seal ring and an O ring, and the seal ring is sleeved outside the plunger rod; the middle seal structure includes a sealing block; the opening of the first lower mounting slot includes an annular positioning stage, and the spacer is disposed on the positioning stage; the upper portion of the sealing block is embedded inside the positioning stage and is pressed on the lower surface of the spacer, the lower portion of the sealing block is embedded inside the second upper mounting slot; the inner wall of the sealing block includes a plurality of evenly distributed longitudinal sealing pipes, and the sealing pipes and the sealing block are integrally formed; the sealing pipes are wide on the top and narrow on the bottom, and the lower ends of the sealing pipes are tightly pressed on the outer wall of the plunger rod; a plurality of evenly distributed longitudinal expansion slots are formed between the sealing pipes.

More particularly, wherein the outer wall of the lower portion of the sealing block includes an annular second slot; an inside of the second slot includes a matching second rubber ring; the outer wall of the lower portion of the sealing bloc: is pressed on the inner wall of the second upper mounting slot.

More particularly, wherein the guide sleeve is oil-bearing copper based powder metallurgy material.

Comparing to the prior art, the present invention has the following effects:

The leak-proof plunger pump of the present invention provides a triple-seal system, made up of an upper seal structure, a middle seal structure and a lower seal structure. Even if one seal structure is damaged, the other seal structures can still provide the sealing function, and the leak-tightness between the plunger rod and the plunger base is always guaranteed, effectively avoiding liquid leakage to cause unstable pressure boost and maintaining good performance of the plunger pump.

In the present invention, the guide sleeves of the leak-proof plunger pump are respectively located on the upper and lower ends of the plunger rod, and can effectively limit the motion path of the plunger rod, allowing the plunger rod to only have up-and-down vertical movement. Coaxiality between the plunger rod, the guide sleeve and the reciprocation hole of the plunger base is always maintained to avoid deflection of the plunger rod, so that uneven wear of the seal ring due to deflection of the plunger rod will not happen, and the life cycle of the seal ring as well, as the sealing quality an be enhanced.

### BRIEF DESCRIPTION OF THE DRAWINGS

FIG. 1 is a schematic view of the structure of Embodiment 1 of the leak-proof plunger pump according to the present invention;

FIG. 2 is an enlarged view of Portion A in FIG. 1;

FIG. 3 is a schematic view of the structure of Embodiment 2 of the leak-proof plunger pump according to the present invention;

FIG. 4 is an enlarged view of Portion B in FIG. 3.

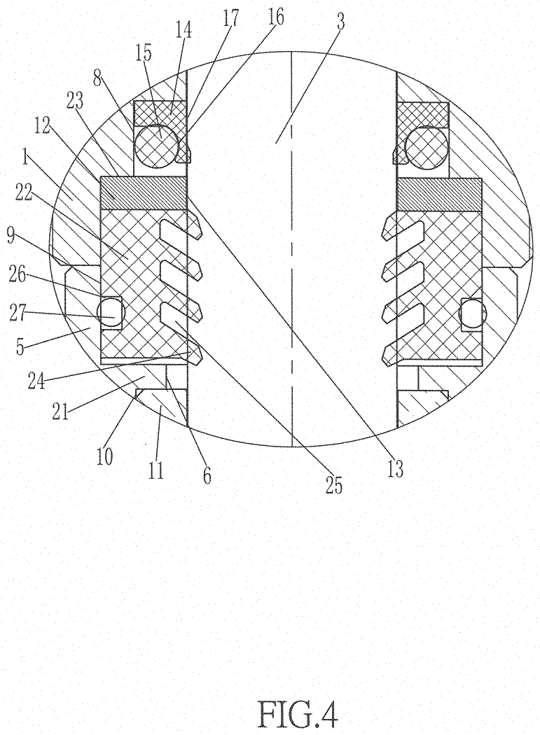

### DETAILED DESCRIPTION OF THE INVENTION

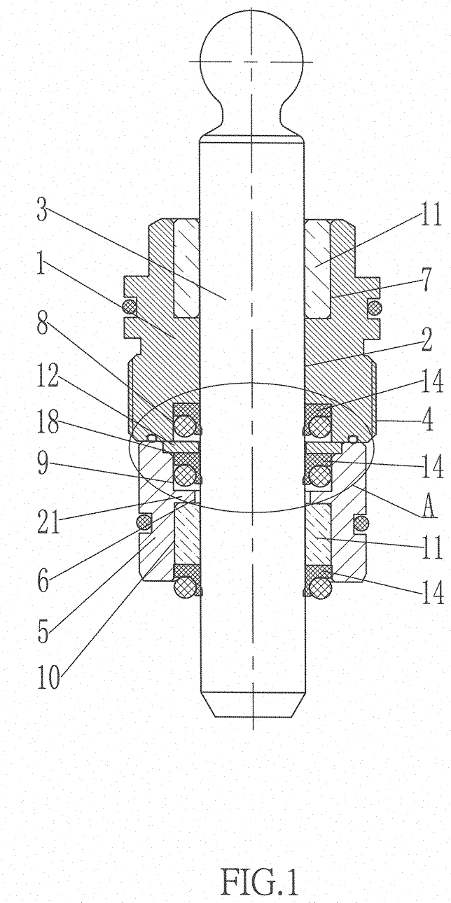

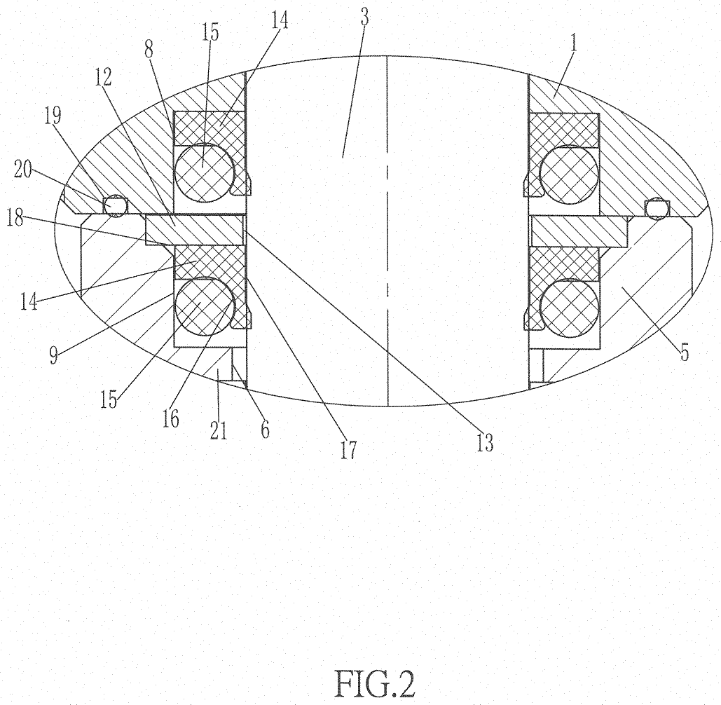

Embodiment I is disclosed in FIG. 1 and FIG. 2. As disclosed, the leak-proof plunger pump of the present invention comprise a plunger base 1, a reciprocation hole 2 configured on the plunger base 1; and a plunger rod 3 matching the reciprocation hole 1 The outer wall of the lower portion of the plunger base 1 is configured with external threads 4, and a plug gasket 5 is configured below the plunger base I; said plug gasket 5 is configured with a movement hole 6 matching the plunger rod 3, the upper surface of said plunger base I is configured with a first upper mounting slot 7, whereas the lower surface of said plunger base 1 is configured with a first lower mounting slot 8; the upper surface of said plug gasket 5 is configured with a second upper mounting slot 9, whereas the lower surface of said plug gasket 5 is configured with a second lower mounting slot 10; a guide sleeve 11 is configured inside both the first upper mounting slot 7 and the second lower mounting slot 10, and the guide sleeves 11 are both sleeved outside the plunger rod 3; the bottom of said first lower mounting slot 8 is configured with an upper seal structure, the inside of said second upper mounting slot 9 is configured with a middle seal structure, the opening of said second lower mounting slot 10 is configured with a lower seal structure, said lower seal structure tightly pressing on the lower surface of the guide sleeve 11 configured inside the second lower mounting slot 10; said upper seal structure and middle seal structure are separated by an annular spacer 12, and there is a movement gap 13 between the inner wall of the spacer 12 and the outer wall of the plunger rod 3.

Said upper seal structure, middle seal structure and lower seal structure are identical, all of the upper seal structure, middle seal structure and lower seal structure are made up of a seal ring 14 and an O ring 15, and the seal ring 14 is sleeved outside the plunger rod 3; the lower portion of said seal ring 14 is configured with an annular lip-shaped slot 16, and the O ring 15 is configured inside the lip-shaped slot 16; there is an adjustment gap 17 between the inner wall of the upper portion of said seal ring 14 and the outer wall of the plunger rod 3, whereas the inner wall of the lower portion of said seal ring 14 is tightly pressed on the outer wall of the plunger rod 3 under the pressure from the O ring 15; the opening of said second upper mounting slot 9 is configured with an annular mounting stage18, and the spacer 12 is configured on the mounting stage18.

The lower surface of said plunger base 1 is configured, with an annular first slot 19; the inside of said first slot 19 is configured with a matching first rubber ring 20; the lower surface of said plunger base 1 is pressed on the upper surface of the plug gasket 5. The existence of the first rubber ring 20 can guarantee the leak-tightness between the plunger base 1 and the plug gasket 5, and consequently the overall leak-tightness of the plunger pump, so that the operational performance of the plunger pump can be further enhanced.

When the seal ring 14 seals the plunger rod 3, the inner wall of the lower portion of said seal ring 14 is tightly pressed on the outer wall of the plunger rod 3 under the pressure from the O ring 15. If there is liquid passing through the gap between the outer wall of the seal ring 14 and the inner wall of the first lower mounting slot 8, the gap between the outer wall of the seal ring 14 and the inner wall of the second upper mounting slot 9, or the gap between the outer wall of the seal ring 14 and the inner wall of the second lower mounting slot 10, and leak over the seal ring 14, the liquid will go into the adjustment gap 17. At this point, the pressure of the liquid will apply on the inner wall of the upper portion of the seal ring 14, forcing it to expand outward. When the seal ring 14 expands outward, the outer wall of the upper portion of the seal ring 14 will tightly press on the inner wall of the first lower mounting slot 8, the inner wall of the second upper mounting slot 9 or the inner wall of the second lower mounting slot 10, effectively preventing the liquid from passing further through the original gap and leak over the seal ring 14. And when the upper portion of the seal ring 14 seals outward, the lower portion of the seal ring 14 seals inward under the force of the O ring 15. Simultaneous sealing by the upper portion and lower portion can maximize the sealing effect of the seal ring 14, and avoid liquid leakage to the maximum extent. Moreover, the spacing portions 21 formed between the spacer 12 or the second upper mounting slot 9 and the second lower mounting slot 10 separate the upper, middle and lower seal rings, so that liquid can go into the adjustment gap 17 and squeeze the seal rings 14 outward, effectively preventing the seal rings 14 from contacting each other, which may lead to inability of the adjustment gap 17 to assist in the sealing.

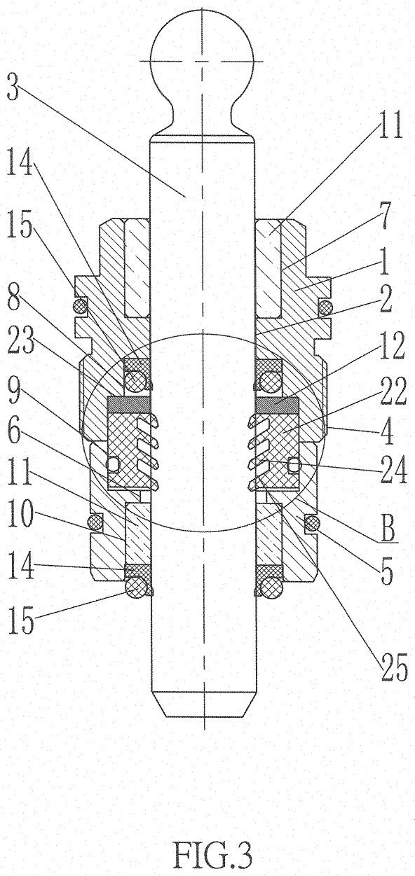

In Embodiment 2, as disclosed in FIG. 3 and FIG, 4, said upper seal structure and lower seal structure are identical. Both the upper seal structure and lower seal structure are made up of a seal ring 14 and an O ring 15, with the seal ring 14 sleeved outside the plunger rod 3; the lower portion of said seal ring 14 is configured with an annular lip-shaped slot 16, and the O ring 15 is configured inside the lip-shaped slot 16; there is an adjustment gap 17 between the inner wall of the upper portion of said seal ring 14 and the outer wall of the plunger rod 3, the inner wall of the lower portion of said seal ring 14 is tightly pressed on the outer wall c f the plunger rod 3 under the pressure of the O ring 15; said middle seal structure includes a sealing block 22; the opening of said first lower mounting slot 8 is configured with, an annular positioning stage 23, and the spacer 12 is configured on the positioning stage 23; the upper portion of said sealing block 22 is embedded inside the positioning stage 23 and is pressed on the lower surface of the spacer 12, and the lower portion of said sealing block 22 is embedded inside the second upper mounting slot 9; the inner wall of said sealing block 22 is configured with several evenly distributed longitudinal sealing pipes 24, the sealing pipes 24 and the sealing block 22 being integrally formed; said sealing pipes 24 are wide on the top and narrow on the bottom, and the lower ends of the sealing pipes 24 are tightly pressed on the outer wall of said plunger rod 3; several evenly distributed longitudinal expansion slots 25 are formed between said sealing pipes 24.

The outer wall of the lower portion of said sealing block 22 is configured with an annular second slot 26; the inside or said second slot 26 is configured with a matching second rubber ring 27; the outer wall of the lower portion of said sealing block 22 is pressed on the inner wall of the second upper mounting slot 9. The existence of the second rubber ring 27 can guarantee the leak-tightness between the plunger base I and the plug gasket 5. and consequently the overall leak-tightness of the plunger pump, so that the operational performance of the plunger pump can be further enhanced.

The sealing method of the upper seal structure and lower seal structure in Embodiment 2 is the same as that of the upper seal structure and lower seal structure in Embodiment 1. When the liquid passes through the lower seal structure and reaches the position of the sealing block 22, the middle seal structure can provide a sealing effect. At this point, the liquid pressure will apply simultaneously on the sealing block 22 or the middle, seal structure and the sealing pipes 24. As the liquid flows upward, the liquid pressure will squeeze the sealing pipes 24 upward. With the sealing pipes 24 being wide on the top and narrow on the bottom, the farther the liquid pressure squeezes the sealing pipes 24 upward, the more tightly the opening of the lower ends of the sealing pipes 24 is pressed on the outer wall of the plunger rod 3, and the better leak-tightness between the sealing pipes 24 and the plunger rod 3 is obtained. Moreover, when the opening of the lower ends of the sealing pipes 24 is constantly pressed tightly on the outer wall of the plunger rod 3, an opposite force will be generated to exert on the sealing block 22 integrally formed with the sealing pipes 24, pushing the sealing block 22 to move outward, and tightly pressing the outer wall of the sealing block 22 on the inner wall of the positioning stage 23 as well as the inner wall of the second upper mounting slot 9, thus further enhancing the leak-tightness of the sealing block 22. Also, when one sealing pipe 24 is tightly pressed on the plunger rod 3, the opening of the lower ends of other sealing pipes above this sealing pipe 24 does not need to be tightly pressed on the outer wall of the plunger rod. This can effectively reduce the friction between the upper sealing pipes 24 and the plunger rod 3, and the lifecycle of the upper sealing pipes 24 can be extended. Consequently, the overall seal life can be extended. Furthermore, several evenly distributed longitudinal expansion slots 25 are formed between the sealing pipes 24. The existence of the, expansion slot 25 can prevent the lower sealing pipes 24 from contacting the neighboring upper sealing pipes 24 when being squeezed upward, allow the lower sealing pipes 24 to have sufficient expansion space, guarantee the independence of the upper sealing pipes 24 to the maximum extent, and maximize the life cycle of the upper sealing pipes 24.

The guide sleeve 11 are respectively located on the upper end and lower end of the plunger rod 3, and can effectively limit the motion path of the plunger rod 3, allowing the plunger rod 3 to only have vertical up-and-down movement. Coaxiality between the plunger rod 3, the guide sleeve 11 and the reciprocation hole 2 of the plunger base 1 is always maintained to avoid deflection of the plunger rod 3, so that, uneven wear of the seal ring 14 due to deflection of the plunger rod 3 will not happen, and the life cycle of the seal, ring 14 as well as the sealing quality can be enhanced. Moreover, the guide sleeve 11 is oil-bearing copper based powder metallurgy material, which is soft and wear-resistant. As it contains oil, it has a self-lubricating effect and good anti-friction quality to effectively reduce the friction between the plunger rod 3 and the guide sleeve 11, avoiding deflection of the plunger rod due to serious wear of the inner wall of the guide sleeve 11.

In summary, the present invention provides a triple-seal system, made up of an upper seal structure, a middle seal structure and a lower seal structure, respectively configured on the first lower mounting slot 8, the second upper mounting slot 9, and the second lower mounting slot 10. With such a system, even if one seal structure is damaged, the other seal structures can still provide the sealing function, and the leak-tightness between the plunger rod 3 and the plunger base I is always guaranteed, effectively avoiding liquid leakage to cause unstable pressure boost and maintaining good performance of the plunger pump.

We claim:

1. A leak-proof plunger pump, comprising:
a plunger base, a reciprocation hole configured on the plunger base, and a plunger rod matching the reciprocation hole; the plunger base having external threads disposed on an outer wall of a lower portion thereof;
wherein the plunger base includes a plug gasket disposed therebelow, a movement hole disposed on the plug gasket and matching the plunger rod, a first upper mounting slot disposed on an upper surface of the plunger base, and a first lower mounting slot disposed on a lower surface of the plunger base;
wherein the plug gasket includes a second upper mounting slot disposed on an upper surface thereof and a second lower mounting slot disposed on a lower surface thereof; both the first upper mounting slot and the second lower mounting slot includes a guide sleeve disposed therein, and the guide sleeves are both sleeved outside the plunger rod; a bottom of the first lower mounting slot has an upper seal structure, an inside of the second upper mounting slot has a middle seal structure, an opening of the second lower mounting slot has a lower seal structure, the lower seal structure tightly pressing on the lower surface of the guide sleeve disposed inside the second lower mounting slot; the upper seal structure and middle seal structure are separated by an annular spacer, and the inner wall of the spacer and the outer wall of the plunger rod have a movement gap disposed therebetween.

2. The leak-proof plunger pump defined in claim 1, wherein the upper seal structure, middle seal structure and lower seal structure are identical, all of the upper seal structure, middle seal structure and lower seal structure are made up of a seal ring and an O ring, and the seal ring is sleeved outside the plunger rod; a lower portion of the seal ring includes an annular lip-shaped slot, and the O ring is disposed inside the lip-shaped slot; the inner wall of the upper portion of the seal ring and the outer wall of the plunger rod include an adjustment gap disposed therebetween, whereas the inner wall of the lower portion of the seal ring is tightly pressed on the outer wall of the plunger rod under the pressure from the O ring; an opening of the second upper mounting slot has an annular mounting stage, and the spacer is disposed on the mounting stage.

3. The leak-proof plunger pump defined in claim 2, wherein the lower surface of the plunger base includes an annular first slot; and an inside of the first slot has a matching first rubber ring; the lower surface of the plunger base is pressed on the upper surface of the plug gasket.

4. The leak-proof plunger pump defined in claim 1, wherein the upper seal structure and lower seal structure are identical, the upper seal structure and lower seal structure are both made up of a seal ring and an O ring, and the seal ring is sleeved outside the plunger rod; the middle seal structure includes a sealing block; the opening of the first lower mounting slot includes an annular positioning stage, and the spacer is disposed on the positioning stage; the upper portion of the sealing block is embedded inside the positioning stage and is pressed on the lower surface of the spacer, the lower portion of the sealing block is embedded inside the second upper mounting slot; the inner wall of the sealing block includes a plurality of evenly distributed longitudinal sealing pipes, and the sealing pipes and the sealing block are integrally formed; the sealing pipes are wide on the top and narrow on the bottom, and the lower ends of the sealing pipes are tightly pressed on the outer wall of the plunger rod; a plurality of evenly distributed longitudinal expansion slots are formed between the sealing pipes. The leak-proof plunger pump defined in claim 4, wherein the outer

5. wall of the lower portion of the sealing block includes an annular second slot; an inside of the second slot includes a matching second rubber ring; the outer wall of the lower portion of the sealing block is pressed on the inner wall of the second upper mounting slot.

6. The leak-proof plunger pump defined in claim 1, wherein the guide sleeve is oil-bearing copper based powder metallurgy material.
